(19) United States
(12) Patent Application Publication
(10) Pub. No.: US 2023/0011812 A1
(43) Pub. Date: Jan. 12, 2023

(54) OPTICAL IMAGING LENS

(71) Applicant: Eterge Opto-Electronics Co., Ltd., Taichung City (TW)

(72) Inventors: Tsu-Meng Lee, Taichung City (TW); Chih-Cheng Hsu, Taichung City (TW)

(73) Assignee: Eterge Opto-Electronics Co., Ltd., Taichung City (TW)

(21) Appl. No.: 17/368,776

(22) Filed: Jul. 6, 2021

(51) Int. Cl. G02B 7/02; H05B 1/02

(52) U.S. Cl. CPC G02B 7/028; G02B 7/021; H05B 1/0294; H05B 2203/013

(57) ABSTRACT

An optical imaging lens including an optical lens assembly with an optical axis, a lens barrel and a conductive element is disclosed. The optical lens assembly includes a plurality of lenses. The lens barrel includes an inner wall surface and a heating film, wherein the inner wall surface surrounds the optical axis and is made of electrical insulating material, and the heating film is formed on the inner wall surface. The optical lens assembly is disposed in the lens barrel in order from an object side to an image side. An edge of at least one lens of the optical lens assembly contacts the heating film. The conductive element is extended along the inner wall surface of the lens barrel, and is electrically connected to the heating film. One terminal of the conductive element is connected to an external power supply.

### BACKGROUND OF THE INVENTION

### 1. Field of the Invention

The present disclosure relates to an imaging lens, and more particularly to an optical imaging lens with a defogging or defrosting function.

### 2. Description of the Prior Art

Influence of ambient temperature on optical imaging lens varies from environmental tolerance of lens material at different temperature conditions. For example, in the case of an outdoor-used optical imaging lens, such as vehicle imaging lens, sport camera lens, or aerial camera lens, etc., several glass lenses are usually required to reduce the effect of temperature changes on the shape of the lens to provide stable imaging quality. On the contrary, in the case of an indoor-used optical imaging lens, such as home surveillance camera lens, since the indoor environment is usually maintained at a temperature range, plastic lenses could be used to replace glass lenses to reduce the manufacturing cost and weight of the optical imaging lens.

In addition, when the optical imaging lens is used in an environment with a large temperature difference, such as moving from outdoor into indoor, or in a damp and cold weather, moisture in the air is easily condensed onto the lens surface of the optical imaging lens to form fog or frost, which affect the clarity of the image. However, the consumer is not easy to solve the fogging or frosting phenomenon of the optical imaging lens since each piece of the optical lenses is precisely set when the optical imaging lens is assembled.

Therefore, it is an object for the persons of the technical field to provide an optical imaging lens with defogging or defrosting function.

### SUMMARY OF THE INVENTION

In order to solve the above problem, the present disclosure provides an optical imaging lens including an optical lens assembly with an optical axis, a lens barrel and a conductive element. The optical lens assembly includes a plurality of optical lenses. The lens barrel includes an inner wall surface and a heating film, wherein the inner wall surface surrounds the optical axis and includes an electrically insulating material; the heating film is formed on the inner wall surface. The optical lens assembly is arranged in the lens barrel in order from an object side to an image side, wherein a side edge of at least one of the optical lenses contacts the heating film. The conductive element extends on the inner wall surface of the lens barrel and is electrically connected to the heating film, wherein one terminal of the conductive element is electrically connected to an external power supply.

According to one embodiment of the present disclosure, the optical imaging lens further includes a heating element, wherein the heating element is positioned at an optical non-effective area of a first lens of the plural optical lenses; another terminal of the conductive element is electrically connected to the heating element.

According to one embodiment of the present disclosure, the edges of the plural optical lenses of the optical lens assembly contact the heating film.

According to one embodiment of the present disclosure, the lens barrel includes plastic material.

According to one embodiment of the present disclosure, the lens barrel includes thermal insulation material.

According to one embodiment of the present disclosure, a thermal conductivity coefficient of the thermal insulation material is lesser than 0.3 W/m·k.

According to one embodiment of the present disclosure, the thermal insulation material includes glass fiber, micro/nano hollow particles, aerogel, nanoporous, or inorganic particles.

According to one embodiment of the present disclosure, a thermal conductivity coefficient of the lens barrel is lesser than 0.15 W/m·k.

According to one embodiment of the present disclosure, the conductive element is positioned on the heating film.

According to one embodiment of the present disclosure, the heating film includes carbon black.

According to one embodiment of the present disclosure, the conductive element includes two conductive wires.

According to one embodiment of the present disclosure, the two conductive wires includes conductive adhesive.

According to one embodiment of the present disclosure, the two conductive wires include metal paste.

According to one embodiment of the present disclosure, the optical imaging lens further includes a thermal insulation layer formed on the inner wall surface of the lens barrel, wherein the heating film is formed on the thermal insulation layer.

According to one embodiment of the present disclosure, the heating element includes a carbon black heating film.

According to one embodiment of the present disclosure, the heating element includes a heating pad.

According to one embodiment of the present disclosure, the optical imaging lens further includes a retainer positioned at a front end of the lens barrel to fix the first lens.

According to one embodiment of the present disclosure, the retainer includes plastic material.

According to one embodiment of the present disclosure, the retainer further includes thermal insulation material.

According to one embodiment of the present disclosure, a thermal conductivity coefficient of the retainer is lesser than 0.15 W/m·k.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present disclosure will be described hereinafter with reference to the appended drawings. It is to be noted that all the drawings are shown for the purpose of illustrating the technical concept of the present disclosure or embodiments thereof, in which:

FIG. 1 is a perspective view of the optical imaging lens 100 of the first embodiment according to the present disclosure;

FIG. 2A is a cross-sectional view taken along line A-A of FIG. 1, showing the optical imaging lens 100 of the first embodiment according to the present disclosure;

FIG. 2B is schematic view of the second lens of the optical imaging lens 100 of the first embodiment according to the present disclosure;

FIG. 3A is a cross sectional view taken along line B-B of FIG. 1, showing a top view of the lens barrel of the optical imaging lens 100 of the first embodiment according to the present disclosure;

FIG. 3B is partial, enlarged sectional view of the lens barrel according to dash line box C of FIG. 1;

FIG. 4A is a cross-sectional view of the optical imaging lens 200 of the second embodiment according to the present disclosure; and

FIG. 4B is a schematic view of the first lens 201 of the optical imaging lens 200 according the second embodiment of the present disclosure.

### DETAILED DESCRIPTION

Hereinafter, various embodiments of the present disclosure will described with reference to the accompanying drawings, and the technical features and effects of the present disclosure can be readily understood by considering the various embodiments. The terms mentioned in the following embodiments, such as “up”, “down”, “front”, “back”, “left”, and “right”, etc., are merely references to the directions of the accompanying drawings. Thus, the directional terms used in the embodiments are used to illustrate relative positions of the components and are not intended to limit the present disclosure. In addition, in the drawings, a thickness, a size, and a shape of each of the components are little exaggerated for description.

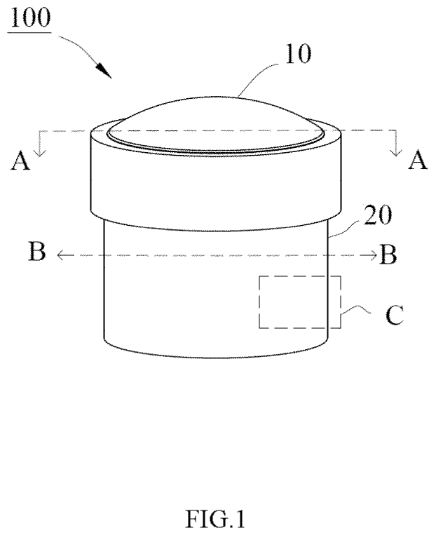

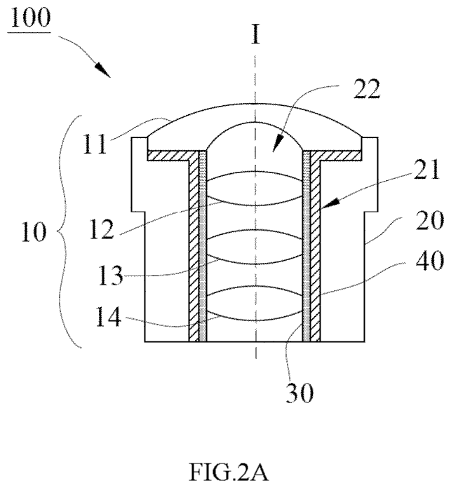

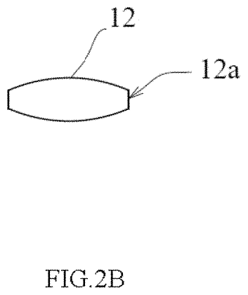

FIG. 1 shows a perspective view of an optical imaging lens 100 of the first embodiment according to the present disclosure. FIG. 2A is a cross-sectional view taken along line A-A of FIG. 1, showing the optical imaging lens 100 of the first embodiment according to the present disclosure. As shown in FIG. 1 and FIG. 2A, the optical imaging lens 100 includes an optical lens assembly 10 with an optical axis I, a lens barrel 20, and a conductive element 30, wherein the lens barrel 20 is capable of heating optical lens to increase the temperature thereof so as to prevent moisture being condensed on the optical lens surface, or to remove fog or frost formed on the optical lens surface. The lens barrel 20 includes an inner wall surface 21 and a heating film 40 positioned on the inner wall surface 21. The conductive element 30 is disposed inside of the lens barrel 20 and is electrically connected to the heating film 40 of the lens barrel 20. The optical lens assembly 10 is arranged inside of the lens barrel 20 in order from an object side to an image side, wherein an edge of at least one optical lens contacts the heating film 40. Another terminal of the conductive element 30 is electrically connected to an external power supply (not shown).

Referring to FIG. 2A, the optical lens assembly 10 of the optical imaging lens 100 includes, in order from an object side to an image side, a first lens 11, a second lens 12, a third lens 13, and a fourth lens 14. Each of the first lens 11 to the fourth lens 14 can be a plastic lens or a glass lens. In the first embodiment, the optical lens assembly 10 of the optical imaging lens 100 includes four optical lenses; however, the present disclosure is not limited thereto. In other embodiments, the optical lens assembly 10 can include two optical lenses, three optical lenses, or other number of optical lenses.

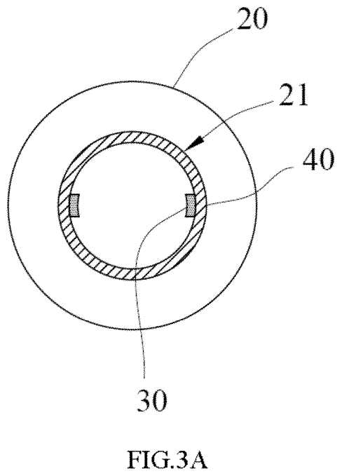

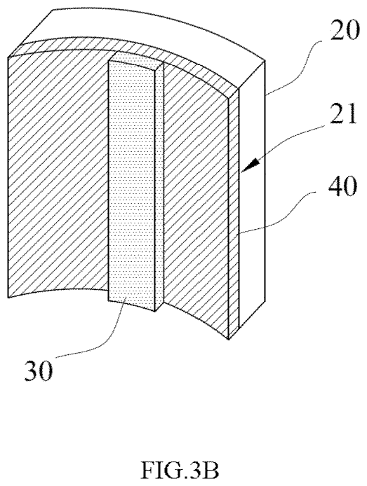

The lens barrel 20 of the optical imaging lens 100 includes the inner wall surface 21, wherein the inner wall surface 21 surrounds the optical axis I of the optical lens assembly 10 and defines an accommodating space 22. The optical lens assembly 10 is arranged in the accommodating space 22 in order. Further referring to FIG. 3A and FIG. 3B, wherein FIG. 3A is a cross sectional view taken along line B-B of FIG. 1, showing a top view of the lens barrel; FIG. 3B is partial, enlarged sectional view of the lens barrel according to dash line box C of FIG. 1. As shown in FIG. 3A and 3B, the lens barrel 20 includes the heating film 40; the heating film 40 is formed on the inner wall surface 21 of the lens barrel 20. The heating film 40 could convert electric energy into heat energy to heat the optical lenses when electricity is applied. The lens barrel 20 can be made of plastic material, but the present disclosure is not limited thereto. In other embodiments, the lens barrel 20 also can be made of metal. When the lens barrel 20 is made of metal, an electrical insulation layer could be further formed inside of the lens barrel 20. For example, a plastic layer could be formed inside of the lens barrel as so to make the inner wall surface 21 be electrically insulated. Preferably, the lens barrel 20 could be formed of plastic composite material which includes thermal insulation material, wherein a thermal conductivity coefficient of the thermal insulation material could be lesser than 0.3 W/m·k. The thermal insulation material could be, for example, glass fiber, micro/nano hollow particles, aerogel, nanoporous, or inorganic particles, etc. In other embodiments, the optical imaging lens 10 could further includes a thermal insulation layer formed on the inner wall surface 21 of the lens barrel 20, wherein the heating film 40 is formed on the thermal insulation layer. The thermal insulation layer could be formed on the inner wall surface 21 of the lens barrel 20 by a coating method. Preferably, a thermal conductivity coefficient of the lens barrel 20 having thermal insulation material could be lesser than 0.15 W/m·k. The heating film 40 could be made of carbon black or carbon black mixing with metallic particles. The method of forming the heating film 40 could be, for example, by coating carbon black onto the inner wall surface 21 of the lens barrel 20 to form a carbon black heating film.

By utilizing a plastic lens barrel or a lens barrel made of plastic composite material which includes thermal insulation material, thermal insulation effect of the optical imaging lens can be enhanced and therefore effectively increase the heating speed of the optical lenses by the heating film. Hence, the temperature of the optical lens can be increased in a short period of time to remove moisture, fog, frost or ice formed on the lens surface to stabilize the imaging quality of the optical imaging lens 100.

The conductive element 30 is disposed inside of the lens barrel 20. In the present embodiment, the conductive element 30 includes two conductive wires. As shown in FIG. 2A, the conductive element 30 is extended on the inner wall surface 21 of the lens barrel 20 and is electrically connected to the heating film 40. In the present embodiment, the conductive element 30 is formed on the heating film 40. Further referring to FIG. 3A and FIG. 3B, the conductive element 30 extends longitudinally on the heating film 40. One terminal of the conductive element 30 is electrically connected to an external power supply (not shown) to provide electricity to the heating film 40. The heating film 40 can convert electric energy into heat energy and provide heating effect.

Each optical lens of the optical lens assembly 10 includes side edges. For example, FIG. 2B is a schematic view of the second lens 12 of the optical imaging lens 100 according to the first embodiment of the present disclosure, and as shown in FIG. 2B, the second lens 12 includes side edges 12a. The optical lenses of the optical lens assembly 10 are assembled into the lens barrel 20 via the side edges thereof and abut the inner wall surface 21 of the lens barrel 20. Therefore, each side edge of each optical lens contacts the heating film 40 and could be heated by the heating film 40 when electricity is applied to the conductive element 30. In the present embodiment, all of the side edges of the first lens 11, the second lens 12, the third lens 13 and the fourth lens 14 of the optical lens assembly 10 contact the heating film 40 of the lens barrel 20, hence when electric current is applied to the conductive element 30, the first lens 11, the second lens 12, the third lens 13 and the fourth lens 14 could be heated by the heating film 40, however, the present disclosure is not limited thereto. In other embodiments, depending on a predetermined piece of optical lens to be heated, a forming position of the heating film 40 of the optical imaging lens 100 could be changed. For example, the heating film 40 could be formed on part of the inner wall surface 21 of the lens barrel 20 in an annular shape to heat a predetermined optical lens.

The conductive element 30 could be formed by conductive adhesive, metal paste or metal wires, etc., wherein the metal paste includes silver paste. When the conductive element 30 is made of conductive adhesive or metal paste, the conductive element 30 can be formed on the inner wall surface 21 of the lens barrel 20 by coating, printing or an adhesive method. According to the present embodiment, the conductive element 30 is formed on the heating film 40, but the present disclosure is not limited thereto. In other embodiments, the conductive element 30 also could be formed between the heating film 40 and the inner wall surface 21 of the lens barrel 20. In addition, in order to provide external insulation for the conductive element 30, the conductive element 30 could be covered with a layer of insulation material.

By the structure disclosed above, the optical imaging lens 100 of the present disclosure is capable of increasing the temperature of the optical lenses to prevent moisture being condensed or to remove fog or frost condensed on the lens surface by heating the optical lenses. Hence, when the imaging quality of the optical imaging lens is affected by the moisture condensed on the lens surface due to low environmental temperature, the optical imaging lens of the present disclosure could activate the heating function to heat the optical lenses, thereby enabling the optical lens assembly to form clear images to provide stable imaging quality. The heating film of the optical imaging lens is formed on the inner wall surface of the lens barrel, providing advantages of simple structure and easy manufacturing.

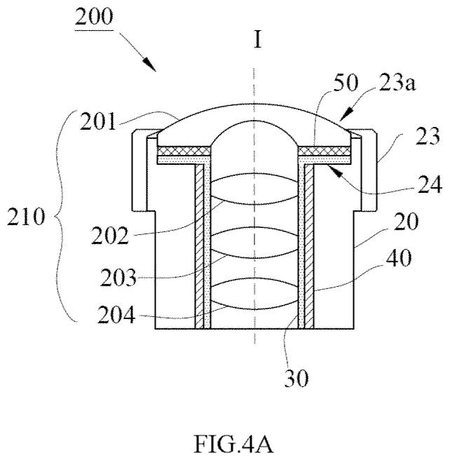

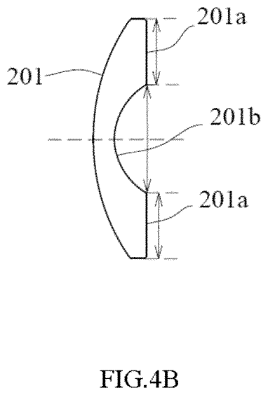

Referring to FIG. 4A, a cross-sectional view of an optical imaging lens 200 of a second embodiment according to the present disclosure is shown. As shown in the FIG. 4A, the optical imaging lens 200 of the second embodiment is different from the optical imaging lens 100 of the first embodiment in that the optical imaging lens 200 of the present embodiment further includes a heating element 50, which is formed under the first lens 201 of the optical lens assembly 210. According to the present embodiment, the optical lens assembly 210 includes a first lens 201, a second lens 202, a third lens 203 and a fourth lens 204. Further referring to FIG. 4B, a schematic view of the first lens 201 of the optical imaging lens 200 according the second embodiment of the present disclosure is shown. As shown in the figure, the first lens 201 includes an optical non-effective area 201a and an optical effective area 201b. The optical non-effective area 201a is an opaque part and the optical effective area 201b is a light-transmissive part which light can be transmitted through to the image side. In the present embodiment, the heating element 50 of the optical imaging lens 200 is disposed under the optical non-effective area 201a of the first lens 201. The heating element 50 could provide heating and light-blocking effect to the first lens 201. As shown in FIG. 4A, the conductive element 30 further extends to a region beneath the optical non-effective part 201b of the first lens 201 and is electrically connected to the heating element 50. The heating element 50 could be formed by thermal conductive materials and could include a heating film or heating pad. In the present embodiment, the heating element 50 is a heating film formed by carbon black, wherein the forming method thereof could be, for example, by coating carbon black onto the optical non-effective area 201a of the first lens 201. In other embodiments, the heating element 50 also could be a heating film formed by carbon black mixed with metallic particles, or a heating pad such as a Polyimide thin film heating pad or a silicone heating pad, etc.

As shown in FIG. 4A, the optical imaging lens 200 of the second embodiment according to the present disclosure further includes a retainer 23. The retainer 23 is mounted on the top of the lens barrel 20 and could be used to fix the first lens 201. The retainer 23 includes a center opening 23a. The center opening 23a surrounds the optical axis I of the optical lens assembly 210, and forms a light entrance for an object-side surface of the first lens 201. In the present embodiment, the diameter of the center opening 23a of the retainer 23 is smaller than the diameter of the first lens 201. However, in other embodiments, the diameter of the center opening 23a could be larger than or equal to the diameter of the first lens 201. The retainer 23 could include plastic material, and preferably, the retainer 23 could include plastic composite material added with thermal insulation material, wherein the thermal conductivity coefficient of the thermal insulation material could be lesser than 0.3 W/m·k. The thermal insulation material could be, for example, glass fiber, micro/nano hollow particles, aerogel, nanoporous, or inorganic particles, etc. In the present embodiment, the retainer 23 is made by plastic and glass fiber, but the present disclosure is not limited thereto. By adding glass fiber into the material of the retainer 23, it is favorable to increase mechanical strength of the retainer 23. In addition, the thermal insulation effect of the retainer could be improved since glass fiber has a low thermal conductivity coefficient, thereby increasing the heating speed of the heating element 50 to the optical lens. Preferably, a thermal conductivity coefficient of the retainer 23 having thermal insulation material could be lesser than 0.15 W/m·k.

The lens barrel 20 includes an abutting surface 24 at a top end thereof, wherein the abutting surface 24 is substantially a planar surface. In the second embodiment, the abutting surface 24 is formed on the top end of the lens barrel 20. When the first lens 201 is assembled to the lens barrel 20, the optical non-effective area 201a of the first lens 201 abuts the abutting surface 24. As shown in the figure, the conductive element 30 of the optical imaging lens 200 of the second embodiment is extended from the inner wall surface 22 of the lens barrel 20 to the abutting surface 24 of the lens barrel 20, and is disposed between the heating element 50 and the abutting surface 24. Hence, when electricity is applied to the heating film 40 and the heating element 50 via the conductive element 30, the heating film 40 could be used to heat the second lens 202, the third lens 203, and the fourth lens 204, while the heating element 50 could be used to heat the first lens 201. According to the present embodiment, the heating element 50 is disposed under the first lens 201 located at an object side of the optical lens assembly 210 and is used to heat the first lens 201, but the present disclosure is not limited thereto. The heating element also could be disposed at a region adjacent to the second lens 202 or other piece of optical lens.

By the structure disclosed above, the optical imaging lens 200 of the present disclosure could heat the optical lenses by utilizing of the heating element and the heating film simultaneously, hence being capable of quickly increasing the temperature of the optical lenses to prevent moisture condensing or to remove fog or frost formed on the lens surface.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical imaging lens, comprising:
an optical lens assembly with an optical axis including a plurality of optical lenses;
a lens barrel including an inner wall surface and a heating film, wherein the inner wall surface surrounds the optical axis and includes an electrically insulating material; the heating film is formed on the inner wall surface; the optical lens assembly is arranged in the lens barrel in order from an object side to an image side; a side edge of at least one of the optical lenses contacts the heating film; and
a conductive element, extending on the inner wall surface of the lens barrel and being electrically connected to the heating film, wherein one terminal of the conductive element is electrically connected to an external power supply.

2. The optical imaging lens of claim 1, further comprising:
a heating element, wherein the plural optical lenses includes a first lens having an optical non-effective area; the heating element is positioned at the optical non-effective area; another terminal of the conductive element is electrically connected to the heating element.

3. The optical imaging lens of claim 2, wherein edges of the plural optical lenses of the optical lens assembly contact the heating film.

4. The optical imaging lens of claim 2, wherein the lens barrel includes plastic material.

5. The optical imaging lens of claim 2, further comprising a thermal insulation layer formed on the inner wall surface of the lens barrel, wherein the heating film is formed on the thermal insulation layer.

6. The optical imaging lens of claim 2, wherein the lens barrel includes thermal insulation material.

7. The optical imaging lens of claim 6, wherein a thermal conductivity coefficient of the thermal insulation material is lesser than 0.3 W/m·k .

8. The optical imaging lens of claim 6, wherein the thermal insulation material includes glass fiber, micro/nano hollow particles, aerogel, nanoporous, or inorganic particles.

9. The optical imaging lens of claim 1, wherein a thermal conductivity coefficient of the lens barrel is lesser than 0.15 W/m·k.

10. The optical imaging lens of claim 2, wherein the conductive element is positioned on the heating film.

11. The optical imaging lens of claim 2, wherein the heating film includes carbon black.

12. The optical imaging lens of claim 2, wherein the conductive element includes two conductive wires.

13. The optical imaging lens of claim 12, wherein the two conductive wires includes conductive adhesive.

14. The optical imaging lens of claim 12, wherein the two conductive wires include metal paste.

15. The optical imaging lens of claim 2, wherein the heating element includes a carbon black heating film.

16. The optical imaging lens of claim 2, wherein the heating element includes a heating pad.

17. The optical imaging lens of claim 2, further comprising a retainer positioned at a front end of the lens barrel to fix the first lens.

18. The optical imaging lens of claim 17, wherein the retainer includes plastic material.

19. The optical imaging lens of claim 18, wherein the retainer further includes thermal insulation material.

20. The optical imaging lens of claim 17, wherein a thermal conductivity coefficient of the retainer is lesser than 0.15 W/m·k.
